(19) United States
(12) Patent Application Publication
(10) Pub. No.: US 2019/0242487 A1
(43) Pub. Date: Aug. 8, 2019

(54) TAP

(71) Applicants: Foshan Shunde Midea Water Dispenser Manufacturing Co., Ltd., Foshan, Guangdong Province (CN); MIDEA GROUP CO., LTD., Foshan, Guangdong Province (CN)

(72) Inventors: Xiaobin Kong, Foshan (CN); Qiyuan Feng, Foshan (CN)

(21) Appl. No.: 16/342,530

(22) PCT Filed: May 19, 2017
(86) PCT No.: PCT/CN2017/085188

§ 371 Date: Apr. 17, 2019

(30) Foreign Application Priority Data
Nov. 30, 2016 (CN) 201611088375.3
Nov. 30, 2016 (CN) 201621307565.5
Nov. 30, 2016 (CN) 201621307701.0

(51) Int. Cl. F16K 11/00; E03C 1/04; F16K 31/60

(52) U.S. Cl. CPC F16K 19/006; E03C 1/0412; F16K 27/06; F16K 31/602; E03C 1/0401

(57) ABSTRACT

The present disclosure provides a tap, which includes a water channel and a body shell, the water channel is internally provided with a spool valve cavity, a water inlet passage and a water outlet passage, the water inlet passage and the water outlet passage are both connected with the spool valve cavity; the water channel is located inside the body shell, the water channel is made of lead-free material.

### CROSS-REFERENCED APPLICATIONS

The present application is a national phase application of International Application No. PCT/CN2017/085188, filed on May 19, 2018, which claims the priorities to Chinese Applications No. 201611088375.3, 201621307701.0, and 201621307565.5, filed at Chinese Patent Office on Nov. 30, 2016, and entitled “TAP”, the entire contents of which are herein incorporated by reference.

### FIELD OF THE DISCLOSURE

The present disclosure relates to the technology field of clean water industry and kitchen manufacturing, and in particular, to a tap.

### BACKGROUND OF THE DISCLOSURE

The existing tap, body shell, water channel, inlet pipe, and outlet pipe of a water filter are all made of copper, a spool valve of the water filter is made of ceramic. The body shell is integrated with the water channel through casting, and external surfaces of the body shell and the water channel are electroplated. External surfaces of the inlet pipe and outlet pipe are electroplated. The materials of inner surfaces of the water channel, the inlet pipe and the outlet pipe which are all contacting with water, are copper containing lead, the lead and other heavy metals contained in the materials can precipitate into water, clean water coming out of the tap can be contaminated by the precipitated lead and other heavy metals, thus affecting human health.

### SUMMARY OF THE DISCLOSURE

The main aim of the present disclosure is to provide a tap, which aims to solve the problem of that the clean water coming out of the tap can be contaminated by the precipitated lead and other heavy metals.

In order to achieve the above aim, the tap provided by the present disclosure includes a water channel and a body shell, the water channel is internally provided with a spool valve cavity, a water inlet passage and a water outlet passage, the water inlet passage and the water outlet passage are both connected with the spool valve cavity; the water channel is located inside the body shell, the water channel is a water channel made of lead-free material.

In one embodiment, the water channel is a water channel made of a plastic or stainless steel.

In one embodiment, the water channel is a water channel made of PPO, PA or PPS.

In one embodiment, the tap further includes a spool valve, a spool valve shaft seat, a holder seat and a holder rod, the spool valve is located inside the spool valve cavity, the holder rod brings the spool valve to rotate through the spool valve shaft seat and controls the water inlet passage to be connected with or separated from the water outlet passage.

In one embodiment, the spool valve is a spool valve made of a ceramic, a plastic, copper, or stain steel.

In one embodiment, the tap further includes an inlet pipe and an outlet pipe, the inlet pipe is connected with the water inlet passage, the outlet pipe is connected with the water outlet passage.

In one embodiment, the outlet pipe is an integrated water pipe made of stain steel, an end of the outlet pipe connecting with the water outlet passage defines two 0-ring seals.

In one embodiment, the outlet pipe is a double layers pipe, which includes an inner layer made of a plastic, and an outer layer made of a metal, the inner layer of the outlet pipe is connected with the water outlet passage through a thread element or a quick union, and the thread element or the quick union is made of a plastic.

In one embodiment, the inlet pipe is an integrated water pipe made of a plastic or stain steel.

In one embodiment, the inlet pipe is a double layers pipe, which includes an inner layer made of a plastic, and an outer layer made of a metal.

In one embodiment, the body shell includes a first end and a second end, the first end is adjacent to the outlet pipe, the second end is adjacent to the inlet pipe; the water channel comprises a third end and a fourth end, the third end is connected with the first end, the fourth end is connected with the second end, fixing the water channel inside of the body shell.

In one embodiment, an inner surface of the first end defines a limiting shoulder, the third end defines a boss, the limiting shoulder abuts the boss.

In one embodiment, an inner surface of the first end defines a thread, the third end is connected with the first end through the thread.

In one embodiment, the fourth end is connected with the second end through a stopping ring or thread.

In one embodiment, the outlet pipe is fixed with the body shell through a body decorating cover.

In one embodiment, an external diameter of a wall body of the body shell adjacent to the inlet pipe, and an external diameter of the wall body of the body shell adjacent to the outlet pipe are larger than an external diameter of the wall body located at a middle part of the body shell.

In one embodiment, the water channel includes a first part and a second part, a first end of the first part is fixed with the body shell through the stopping ring, the other end of the first part is connected with the second part through a thread; one end of the second part disconnected with the first part is fixed with the body shell through the stopping ring.

In one embodiment, an external diameter of a wall body of the body shell is gradually decreasing along a direction from the inlet pipe to the outlet pipe.

In one embodiment, the body shell is cylinder-shaped or square pillar shape.

The tap provided by the present disclosure adopts a principle of a hierarchical design, to enable that the water channel, an inlet pipe, an outlet pipe which are all connected with water, can be separated from the body shell of the tap, the water channel, the inlet pipe, the outlet pipe and the spool valve are all made of lead-free material, an outlet end of the outlet pipe of the tap is connected with an inlet hole of the water channel, the spool valve is connected with the water inlet passage and the water outlet passage of the water channel, respectively, an inlet hole of the outlet pipe is connected with the water outlet passage of the water channel, therefore the inlet pipe, the water channel, the spool valve and the outlet pipe of the tap form a lead-free water channel, and the interior of the lead-free water channel is unblocked. When the inlet pipe of the tap is connected with a water filter, filtered clean water passes through the lead-free water channel, there is no precipitated lead and other heavy metals, the requirement of national tap lead-free standard is actually achieved, consumers' water security is guaranteed.

### BRIEF DESCRIPTION OF THE DRAWINGS

Embodiments of the present disclosure are described in the accompanying drawings introduced briefly in the following. Apparently, the accompanying drawings in the following description are only about some embodiments of the present disclosure.

FIG. 1 is a part cross section diagram of a tap of the present disclosure according to an exemplary embodiment;

FIG. 2 is an enlarged diagram of A part shown in FIG. 1.

### LABELS ILLUSTRATION FOR DRAWINGS

| Label | Name | Label | Name |
|---|---|---|---|
| 1 | outlet pipe | 52 | first end |
| 3 | body decorating cover | 53 | second end |
| 4 | water channel | 6 | first lock nut |
| 41 | water outlet passage | 7 | holder rod |
| 42 | water inlet passage | 8 | holder seat |
| 43 | boss | 9 | spool valve |
| 44 | third end | 10 | spool valve shaft seat |
| 45 | fourth end | 11 | spool valve shell |
| 5 | body shell | 13 | inlet pipe |
| 51 | limiting shoulder | | |

The realizing of the aim, functional characteristics, advantages of the present disclosure are further described in detail with reference to the accompanying drawings and the embodiments.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure.

It is to be understood that, all the directional instructions of in the present disclosure (such as top, down, left, right, front, back) can only be used for explaining relative position relations, moving condition of the elements under a special form (referring to figures), and so on, if the special form changes, the directional instructions changes accordingly.

In addition, the descriptions, such as the “first”, the “second” in the present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In the description of the present disclosure, “a plurality of” means at least two, such as two, three, and so on, unless specifically limited otherwise.

In the present disclosure, unless specified or limited otherwise, the terms “connected”, “fixed” and the like are used broadly, and for example, “fixed” can be fixed connections, detachable connections, or integral connections; may also be mechanical or electrical connections; may also be direct connections or indirect connections via intervening structures, may also be inner connecting of two elements, or interaction relationship between two elements, unless specifically limited otherwise.

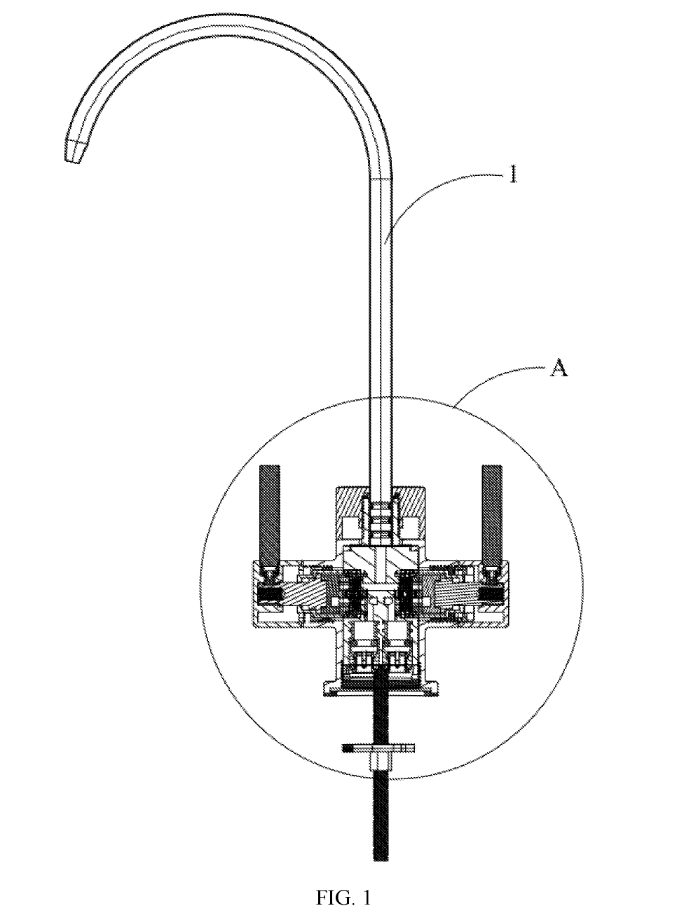

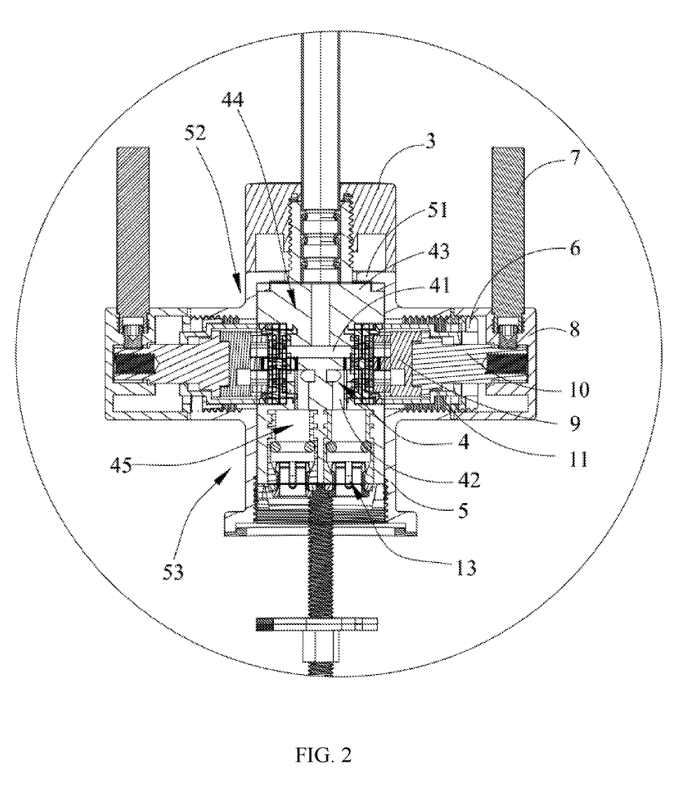

Please referring to FIG. 1 and FIG. 2, in an exemplary embodiment of the present disclosure, the tap includes a water channel 4 and a body shell 5, the water channel 4 is internally provided with a spool valve cavity, a water inlet passage 42 and a water outlet passage 41, the water inlet passage 42 and the water outlet passage 41 are both connected with the spool valve cavity; the water channel 4 is located inside the body shell 5, the water channel 4 is a water channel 4 made of lead-free material.

The tap provided by the present disclosure adopts a principle of a hierarchical design, to enable that the water channel 4, an inlet pipe 13, an outlet pipe 1 which are all connected with water, can be separated from the body shell 5 of the tap, the water channel 4, the inlet pipe 13, the outlet pipe 1 and the spool valve 9 are all made of lead-free material, an outlet end of the outlet pipe 13 of the tap is connected with an inlet hole of the water channel 4, the spool valve 9 is connected with the water inlet passage 42 and the water outlet passage 41 of the water channel 4, respectively, an inlet hole of the outlet pipe 1 is connected with the water outlet passage 41 of the water channel 4, therefore the inlet pipe 13, the water channel 4, the spool valve 9 and the outlet pipe 1 of the tap form a lead-free water channel 4, and the interior of the lead-free water channel 4 is unblocked. When the inlet pipe 13 of the tap is connected with a water filter, filtered clean water passes through the lead-free water channel 4, there is no precipitated lead and other heavy metals, the requirement of national tap lead-free standard is actually achieved, consumers' water security is guaranteed. According to one embodiment of the present disclosure can be applied to water purification equipment industry, drinking water equipment industry, as well as sanitary industry, tea industry, and so on.

There is one method in existing technology to acquire a lead-free tap, that is, the body shell 5, the water channel 4, the inlet pipe 13, the outlet pipe 1 can be made of lead-free stain steel. The disadvantages of this method are that the stain steel is too hard to be manufactured by pressure casting, difficult to cut, which causes that the cost is high, it is not easy to widely popularize and apply. In one embodiment of the present disclosure, the body shell 5 of the tap and the water channel 4 can be designed to be two different parts, the water channel 4 and the body shell 5 of the tap can be manufactured by injecting, casting or cutting molding, an external surface of the body shell 5 of the tap can be electroplated or sprayed, then the water channel 4 can be located inside the body shell 5 of the tap to fix the water channel 4 with the body shell 5 of the tap.

The body shell 5 can be a metal element, or a plastic element. When the body shell 5 is made of plastic, In one embodiment, the plastic is ABS (acrylonitrile-butadiene-styrene copolymer), PPS (polyphenylene sulfide), PC (polycarbonate), or PC/ABS alloy. ABS is one of the five synthetic resins, ABS has good shock resistance, heat resistance, low temperature resistance, chemical resistance and excellent electrical performance, also has the characteristics of easy processing, product size stability, good surface gloss, and so on, ABS is easy to be painted, colored, a secondary operation, such as, spraying metal on surface, electroplating, soldering, hot-pressing, bonding, and so on, can be applied to ABS; PC is polycarbonate, which has many advantages, such as, high strength and elastic coefficient, high impact strength, wide service temperature, low forming shrinkage rate, good size stability, good fatigue resistance, good weather resistance, tasteless and odorless, and PC is harmless to humans and meets hygiene safety; PC/ABS alloy is a modified material of PC, and is a material mixing PC with ABS, which can improve flexural modulus, heat resistance, plating performance, and so on. When the body shell 5 is made of ABS, PPS, PC, or PC/ABS alloy, or other material which is easy to be electroplated or sprayed, the external surface of the body shell 5 can be electroplated or sprayed, so that the appearance of the tap shows metallic luster, or the physical and chemical properties of the tap are further improved.

In one embodiment, the water channel 4 is a water channel 4 made of a plastic or stainless steel.

In one embodiment, the water channel 4 is a water channel 4 made of PPO (polyphenylene oxide), PA (polyamide) or PPS (polyphenylene sulfide). PPO, PA and PPS are all plastic, wherein, PPO is polyphenylene oxide, which has advantages of large rigidity, high heat resistance, fire retardant, high strength, excellent electrical performance, and so on, in addition, PPO also has advantages of wear-resisting, non-poisonous, fouling resistant, and so on; PA is polyamide, which has good comprehensive performance, which includes mechanical property, heat resistance, wear resistance, chemical resistance, self-lubrication, and PA has low friction coefficient, a certain fire retardant, and is easy to machine; PPS is polyphenylene sulfide, which has high temperature resistance, corrosion resistance and superior mechanical property.

In one embodiment, the tap further includes a spool valve 9, a spool valve shaft seat 10, a holder seat 8 and a holder rod 7, the spool valve 9 is located inside the spool valve cavity, the holder rod 7 brings the spool valve 9 to rotate through the spool valve shaft seat 10 and controls the water inlet passage 42 to be connected with or separated from the water outlet passage 41.

In one embodiment, the spool valve 9 is a spool valve 9 made of a ceramic, a plastic, copper, or stain steel.

In one embodiment, the tap further includes an inlet pipe 13 and an outlet pipe 1, the inlet pipe 13 is connected with the water inlet passage 42, the outlet pipe 1 is connected with the water outlet passage 41.

In one embodiment, the outlet pipe 1 is an integrated water pipe made of stain steel, an end of the outlet pipe 1 connecting with the water outlet passage 41 defines two O-ring seals. In detail, at an end of the water outlet passage 41 of the water channel 4, the outlet pipe 1 defines two O-ring seals which can be used for sealing with an inner surface of water channel 4.

In one embodiment, the outlet pipe 1 is a double layers pipe, which includes an inner layer made of a plastic, and an outer layer made of a metal, the inner layer of the outlet pipe 1 is connected with the water outlet passage 41 through a thread element or a quick union, and the thread element or the quick union is made of a plastic.

In one embodiment, the inlet pipe 13 is an integrated water pipe made of stain steel or a plastic.

In one embodiment, the inlet pipe 13 is a double layers pipe, which includes an inner layer made of a plastic, and an outer layer made of a metal.

In detail, the outer layer of the outlet pipe 1 and/or the inlet pipe 13 can be made of copper/alloy pipe, the inner layer of the outlet pipe 1 and/or the inlet pipe 13 can be made of lead-free tube which is flexible, water passes through the tube, and lead cannot come into the water. In addition, the external surface of the outer layer of the outlet pipe 1 and/or the inlet pipe 13 can be electroplated or sprayed, such that the properties of the outlet pipe 1 and/or the inlet pipe 13, such as hardness and corrosion resistance, and so on, can be improved, and the appearance of the outlet pipe 1 and/or the inlet pipe 13 is much more diverse.

In one embodiment, the body shell 5 includes a first end 52 and a second end 53, the first end 52 is adjacent to the outlet pipe 1, the second end 53 is adjacent to the inlet pipe 13; the water channel 4 includes a third end 44 and a fourth end 45, the third end 44 is connected with the first end 52, the fourth end 45 is connected with the second end 53, fixing the water channel 4 inside the body shell 5. In detail, the body shell 5 is internally provided with a receiving space, the water channel 4 is received in the receiving space, and two ends of the water channel 4 are connected with an inner wall of the body shell 5, respectively, such fixing the water channel 4 with the body shell 5 is realized.

As a preferred exemplary embodiment of the present disclosure, an inner surface of the first end 52 defines a limiting shoulder 51, the third end 44 defines a boss 43, the limiting shoulder 51 abuts the boss 43. A direction shown in FIG. 1 can be used for confirming a upward direction and a downward direction, the body shell 5 of the tap can be not only an outer part, but also a structural part, the third end 44 (that is, the top of the water channel 4) can be inserted in the body shell 5 of the tap from bottom to top, the third end 44 defines a boss 43 which can be connected with the limiting shoulder 51 of the first end 52 (that is, the top of the body shell 5) of the body shell 5 of the tap for limiting position. The limiting shoulder 51 just abuts the boss 43, and is not fixed with the boss 43, it needs to cooperate with that the second end 53 should be fixed with the fourth end 45 to fix the water channel 4 in the body shell 5.

In another exemplary embodiment, the inner surface of the first end 52 defines a thread, the third end 44 is connected with the first end 52 through the thread. Different from the boss 43 abuts the limiting shoulder, in the exemplary embodiment, the inner surface of the first end 52 defines an inner thread, the external surface of the third end 44 of the water channel 4 defines an outer thread, the first end 52 of the body shell 5 and the third end 44 of the water channel 5 are fixed with each through thread.

Furthermore, the fourth end 45 is connected with the second end 53 through a stopping ring or the thread.

In one embodiment, the outlet pipe 1 is fixed with the body through a body decorating cover 3. The outlet pipe 1 is located in the water channel 4 through the body decorating cover 3, the outlet pipe 1 defines a stopper fixed with the body decorating cover 3, the body decorating cover 3 is fixed with the external surface of the water channel 4 through the thread, the outlet pipe 1 defines two O-ring seals for sealing with the inner surface of the water channel 4.

In order to achieve the diverse of the appearance of the tap, the body can be shaped to various shapes, such as a gourd shape, a taper shape or a pillar shape, and so on, two ends of the gourd is larger than a middle part of the gourd.

In one embodiment, an external diameter of a wall body of the body shell 5 adjacent to the inlet pipe 13, and an external diameter of the wall body of the body shell 5 adjacent to the outlet pipe 1 are larger than an external diameter of the wall body located at a middle part of the body shell 5. At this time, the shape of the body shell 5 is taper.

Furthermore, the water channel 4 includes a first part and a second part, a first end 52 of the first part is fixed with the body shell 5 through the stopping ring, the other end of the first part is connected with the second part through the thread; one end of the second part disconnected with the first part is fixed with the body shell 5 through the stopping ring. In order to fix the water channel 4 in the taper shaped body shell 5, the water channel 4 can be configured to have a multipart form, the water channel 4 can be fix in the body shell 5 in a part connecting form, one part of the water channel 4 is connected with another part of the water channel 4 through the thread, the water channel 4 is fixed with the body shell 5 through the stopping ring.

In one embodiment, an external diameter of the wall body of the body shell 5 is gradually decreasing along a direction from the inlet pipe 13 to the outlet pipe 1. At this time, the shape of the body shell 5 is taper.

In one embodiment, the body shell 5 is cylinder-shaped or square pillar shape.

The connecting relationships among the components of the tap can be concretely illustrated as following.

The outlet pipe 1 can be inserted into a top hole of the water channel 4, that is, an inlet hole of the outlet pipe 1 is connected with the water outlet passage 41 of the water channel 4. An top end of the water channel 4 can be connected with the body shell 5 of the tap, a left end and a right end of the water channel 4 are connected with a left spool valve 9 and a right spool valve 9, respectively, a bottom end of the water channel 4 is connected with the inlet pipe 13 of the tap. A bottom end of the body shell 5 of the tap is connected and fixed with a second lock nut. A left end and right end of the body of the tap are connected with a left holder seat 8 and a right holder seat 8, respectively. A right holder rod 7 is inserted into the right holder seat 8 to be connected with the right spool valve shaft seat 10; the right spool valve shaft seat 10 is connected with the right spool valve 9, a spool valve shell 11, the holder rod 7 and the holder seat 8, respectively; the spool valve shell 11 coils the spool valve 9, and an external surface of the spool valve shell 11 is connected with a first lock nut 6, the first lock nut 6 is connected with the body shell 5 of the tap through thread to lock and fix the spool valve 9; the external surface of the spool valve 9 of the tap is coiled by the spool valve shell 11, an left end of the spool valve 9 is connected with an outlet hole of the water inlet passage 42 on the right of the water channel 4, forming a sealed waterway; a right side of the spool valve 9 is connected with the spool valve shaft seat 10. A top end of the inlet pipe 13 is connected with the water channel 4 to form a sealed waterway, a bottom end of the inlet pipe 13 is connected with the second lock nut, a flange, a lock washer, respectively, the seal ring is connected with the inlet pipe 13 and the inlet hole of the water inlet passage 42 of the water channel 4 for sealing. Wherein, the spool valve 9 is a spool valve 9 made of a ceramic or stainless steel. The double outlet lead-free tap has a structure which is bilaterally symmetric, the connecting modes of the components at the left are the same with the connecting modes of the components at the right, no need to repeat again.

In one embodiment of the present disclosure can also be applied to single outlet lead-free tap. In one embodiment of the single outlet lead-free tap is the same with In one embodiment of the double outlet lead-free tap, the difference is that the double outlet lead-free tap has two water channels 4, which can outlet two kinds of water. While the single outlet lead-free tap only has one water channel 4.

1. A tap, comprising:
a water channel and a body shell, the water channel being internally provided with a spool valve cavity, a water inlet passage and a water outlet passage, the water inlet passage and the water outlet passage being both connected with the spool valve cavity; the water channel being located inside the body shell, wherein the water channel is comprised of lead-free material.

2. The tap of claim 1, wherein the water channel is comprised of a plastic or stainless steel.

3. The tap of claim 1, wherein the water channel is comprised of PPO, PA or PPS.

4. The tap of claim 1, wherein the tap further comprises a spool valve, a spool valve shaft seat, a holder seat and a holder rod, the spool valve is located inside the spool valve cavity, the holder rod brings the spool valve to rotate through the spool valve shaft seat and controls the water inlet passage to be connected with or separated from the water outlet passage.

5. The tap of claim 4, wherein the spool valve is comprised of a ceramic, a plastic, copper, or stain steel.

6. The tap of claim 1, wherein the tap further comprises an inlet pipe and an outlet pipe, the inlet pipe is connected with the water inlet passage, the outlet pipe is connected with the water outlet passage.

7. The tap of claim 6, wherein the outlet pipe is an integrated water pipe made of stain steel, an end of the outlet pipe connecting with the water outlet passage defines two 0-ring seals.

8. The tap of claim 6, wherein the outlet pipe is a double layers pipe, which comprises an inner layer made of a plastic, and an outer layer made of a metal, the inner layer of the outlet pipe is connected with the water outlet passage through a thread element or a quick union, and the thread element or the quick union is comprised of a plastic.

9. The tap of claim 6, wherein the inlet pipe is an integrated water pipe is comprised of a plastic or stain steel.

10. The tap of claim 6, wherein the inlet pipe is a double layers pipe, which comprises an inner layer is comprised of a plastic, and an outer layer made of a metal.

11. The tap of claim 6, wherein the body shell comprises a first end and a second end, the first end is adjacent to the outlet pipe, the second end is adjacent to the inlet pipe; the water channel comprises a third end and a fourth end, the third end is connected with the first end, the fourth end is connected with the second end, fixing the water channel inside of the body shell.

12. The tap of claim 11, wherein an inner surface of the first end defines a limiting shoulder, the third end defines a boss, the limiting shoulder abuts the boss.

13. The tap of claim 11, wherein an inner surface of the first end defines a thread, the third end is connected with the first end through the thread.

14. The tap of claim 12, wherein the fourth end is connected with the second end through a stopping ring or a thread.

15. The tap of claim 11, wherein the outlet pipe is fixed with the body shell through a body decorating cover.

16. The tap of claim 6, wherein an external diameter of a wall body of the body shell adjacent to the inlet pipe, and an external diameter of the wall body of the body shell adjacent to the outlet pipe are larger than an external diameter of the wall body located at a middle part of the body shell.

17. The tap of claim 16, wherein the water channel comprises a first part and a second part, a first end of the first part is fixed with the body shell through the stopping ring, the other end of the first part is connected with the second part through a thread; one end of the second part disconnected with the first part is fixed with the body shell through the stopping ring.

18. The tap of claim 6, wherein an external diameter of a wall body of the body shell is gradually decreasing along a direction from the inlet pipe to the outlet pipe.

19. The tap of claim 6, wherein the body shell is cylinder-shaped or square pillar shape.
